(19) United States
(12) Patent Application Publication
(10) Pub. No.: US 2010/0135653 A1
(43) Pub. Date: Jun. 3, 2010

(54) OPTICAL NETWORK MONITORING SYSTEM AND METHOD THEREOF

(75) Inventors: San-liang Lee, Taipei City (TW); Chun-hung Cheng, Taipei City (TW); Shuen-te Ji, Taipei City (TW)

Correspondence Address: AUSTIN RAPP & HARDMAN, 170 South Main Street, Suite 735, SALT LAKE CITY, UT, 84101, US

(73) Assignee: National Taiwan University of Science and Technology, Taipei City (TW)

(21) Appl. No.: 12/502,672

(22) Filed: Jul. 14, 2009

(30) Foreign Application Priority Data
Dec. 3, 2008 (TW) 097147000

(51) Int. Cl. H04B 17/00

(52) U.S. Cl. 398/25

(57) ABSTRACT

An optical network monitoring system and method thereof are proposed. An optical line terminal (OLT) transmits a first optical signal to a plurality of optical interference devices. After the first optical signal passes the optical interference devices, the optical interference devices reflect back a plurality of second optical signals corresponding to the optical interference devices respectively to the optical line terminal. The second optical signals have different optical path differences. An optical/electrical converter unit converts each of the second optical signals into an electrical signal. A spectrum analyzing unit analyzes the electrical signal to extract a frequency component of the electrical signal, thus the fiber connection status to each optical network unit in the optical network system could be obtained. Therefore, the purpose of monitoring the optical network system is achieved.

### CLAIM OF PRIORITY

This application claims priority to Taiwanese Patent Application No. 097147000 filed on Dec. 3, 2008.

### TECHNICAL FIELD OF THE INVENTION

The present invention relates to a monitoring system and a method thereof, and more particularly to an optical network monitoring system and a method thereof capable of detecting transmission statuses of an optical network.

### BACKGROUND OF THE INVENTION

Computer network has become an important tool for users to obtain information. Network stability is the most important to the users in the earlier days because the users do not wish abnormal network disconnection to happen often. With technological progress, the users are not satisfied with only requirements of network stability. The users are also seeking for a higher network speed. In other words, the users are seeking for both network stability and a higher network speed at the same time.

Fiber has characteristics in high bandwidth, low data loss, high data security, and not to be damaged easily. Other transmission media have no the above-mentioned characteristics. Therefore, fiber is being used more and more as a transmission medium for network systems. In the future, network systems will be developed toward an entire optical network with fiber.

The reasons for data errors in an optical network include active component failure, node failure, human errors, and so on. The human errors occur the most, such as fiber cables that are broken by an excavator, error operations, and fiber cables switching errors. In addition, the active component failure also happens often. The active components include transmitters, receivers, and controllers.

A service of fiber to the home (FTTH) is to directly connect a passive optical network (PON) between an optical line terminal (OLT) and optical network units (ONUs). The optical line terminal is an Internet service provider, and the optical network units are the users. The passive optical network is a one-to-many tree network architecture for the optical line terminal to be utilized by the optical network units.

In order to provide a perfect network quality, the optical line terminal has to find out where a fiber branch is broken when the optical network is disconnected abnormally. Conventionally, an optical time domain reflectometer (OTDR) is utilized to detect transmission statuses of the optical network. The transmission statues are connection statuses from the optical line terminal to the optical network units. However, the optical time domain reflectometer adds each result of fiber branches in the tree network architecture together. Therefore, each status of the fiber branches can not be distinguished. In other words, when there is an event occurring in the optical network, the optical time domain reflectometer can not distinguish the event occurred in which optical network unit. For example, when lengths of at least two fiber branches are the same and an error has occurred in one of the fiber branches, the optical time domain reflectometer can not distinguish where the error has occurred. In another example, when there are errors in at least two fiber branches at the same time, the optical time domain reflectometer can not distinguish where the errors have occurred, either. When errors occur in a dead zone of the optical time domain reflectometer, the optical time domain reflectometer can not distinguish where the errors have occurred, either.

In order to solve the above-mentioned problems, a solution is to utilize fiber Bragg gratings in nodes of the optical network for monitoring the optical network. However, the fiber Bragg gratings can not be manufactured in large quantities, and there are the disadvantages of its bulky size and high production cost. Therefore, the fiber Bragg gratings do not have practical applications.

### SUMMERY OF THE INVENTION

A primary objective of the present invention is to provide an optical network monitoring system. The optical network monitoring system includes an optical line terminal, a plurality of optical interference devices, a beam splitter unit, an optical/electrical converter unit, and a spectrum analyzing unit. The optical line terminal has a wavelength variable light source for transmitting a first optical signal. The optical interference devices are utilized for being passed by the first optical signal and reflecting back a plurality of second optical signals corresponding to the optical interference devices respectively to the optical line terminal. The second optical signals have different optical path differences. The beam splitter unit is connected to the optical line terminal and the optical interference devices via optical fiber respectively, and the beam splitter unit distributes and transmits the first optical signal to the optical interference devices. The optical/electrical converter unit is utilized for converting each of the second optical signals into an electrical signal. The spectrum analyzing unit is utilized for analyzing the electrical signal to extract a frequency component of the electrical signal.

Another objective of the present invention is to provide an optical network monitoring method. The optical network monitoring method includes the following steps. A first optical signal is transmitted from an optical line terminal to a plurality of optical interference devices. A plurality of second optical signals corresponding to the optical interference devices are reflected back to the optical line terminal after the optical interference devices are passed by the first optical signal. The second optical signals have different optical path differences. The optical line terminal receives and analyzes each of the second optical signals which are reflected from the optical interference devices.

Each of the above-mentioned optical interference devices has a different free spectrum range (FSR). The free spectrum range of each of the interference devices is defined as a wavelength difference between adjacent transmission peaks. After the optical interference devices are passed by the first optical signal being modulated, optical interference devices reflect back the second optical signals to the optical line terminal. Then, an optical/electrical converter unit converts each of the second optical signals into an electrical signal. By analyzing the electrical signal to extract a frequency component of the electrical signal, a status of each optical network unit in the optical network monitoring can be shown.

By the optical network monitoring system and the optical network monitoring method of the present invention, an object of monitoring the optical network system can be achieved with a low cost and an easy method. Furthermore, when lengths of fiber branches are the same and at least one error occurs in the fiber branches at the same time, or errors occur in dead zone of an optical time domain reflectometer, the present invention can also distinguish where the error has occurred.

### BRIEF DESCRIPTION OF THE DRAWINGS

FIG. 1 illustrates an architecture diagram of an optical network monitoring system according to the present invention;

FIG. 2A illustrates a diagram of Fabry-Perot etalon;

FIG. 2B illustrates a diagram of Mach-Zehnder interferometer;

FIG. 2C illustrates a diagram of Michelson interferometer;

FIG. 3 illustrates a flow chart of an optical network monitoring method according to the present invention;

FIG. 4 illustrates waveform diagrams of various elements in a channel of the optical network monitoring system according to the present invention;

FIG. 5A illustrates stimulated waveform diagrams in a frequency domain and a time domain when the optical network monitoring system of the present invention is in a normal condition; and

FIG. 5B illustrates stimulated waveform diagrams in a frequency domain and in a time domain when the optical network monitoring system of the present invention includes a broken of a channel.

### DETAILED DESCRIPTION OF THE INVENTION

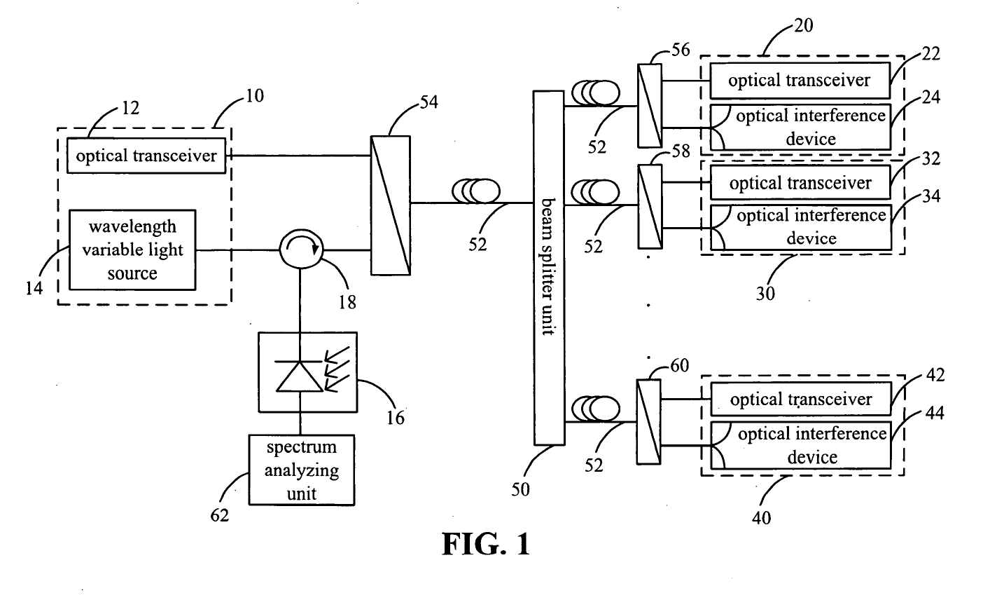

Please refer to FIG. 1. FIG. 1 illustrates an architecture diagram of an optical network monitoring system according to the present invention. The optical network monitoring system includes an optical line terminal 10, optical network units 20, 30, 40, and a beam splitter unit 50. The optical line terminal 10 is utilized for transmitting a first optical signal. The beam splitter unit 50 is connected to the optical line terminal 10 and the optical network units 20, 30, 40, respectively, via optical fiber, and the beam splitter unit 50 distributes and transmits the first optical signal to the optical network units 20, 30, 40. The optical line terminal 10 includes an optical transceiver 12 and a wavelength variable light source 14. The optical network monitoring system further includes an optical circulator 18 and an optical/electrical converter unit 16. The wavelength variable light source 14 is utilized for transmitting the first optical signal whose frequency is modulated with time. The optical network units 20, 30, 40 include an optical transceiver 22, 32, 42 and an optical interference device 24, 34, 44 respectively. The optical interference devices 24, 34, 44 are disposed in a plurality of output ports of the beam splitter 50 respectively. The optical interference devices 24, 34, 44 are utilized for being passed by the first optical signal and reflecting back a plurality of second optical signals corresponding to the optical interference devices 24, 34, 44 respectively to the optical line terminal 10. The optical transceivers 12, 22, 32, 42 are utilized for transmitting and receiving data. The optical network monitoring system further includes wavelength multiplexing/demultiplexing devices 54, 56, 58, 60 for the optical line terminal 10 and the optical network units 20, 30, 40 to perform a many-to-one output or a one-to-many output. It is noted that quantities of the optical network units are not limited to three. Three optical network units 20, 30, 40 are only used as an example.

Each of the optical interference devices 24, 34, 44 is one selected from a group consisting of Fabry-Perot etalon, Mach-Zehnder interferometer, and Michelson interferometer. That is, each of the optical interference devices 24, 34, 44 is one of the three interferometers or combinations of the three interferometers. Each of the optical interference devices 24, 34, 44 has a different free spectrum range. As mentioned above, the free spectrum range of the interference devices 24, 34, or 44 is defined as a wavelength difference between adjacent transmission peaks.

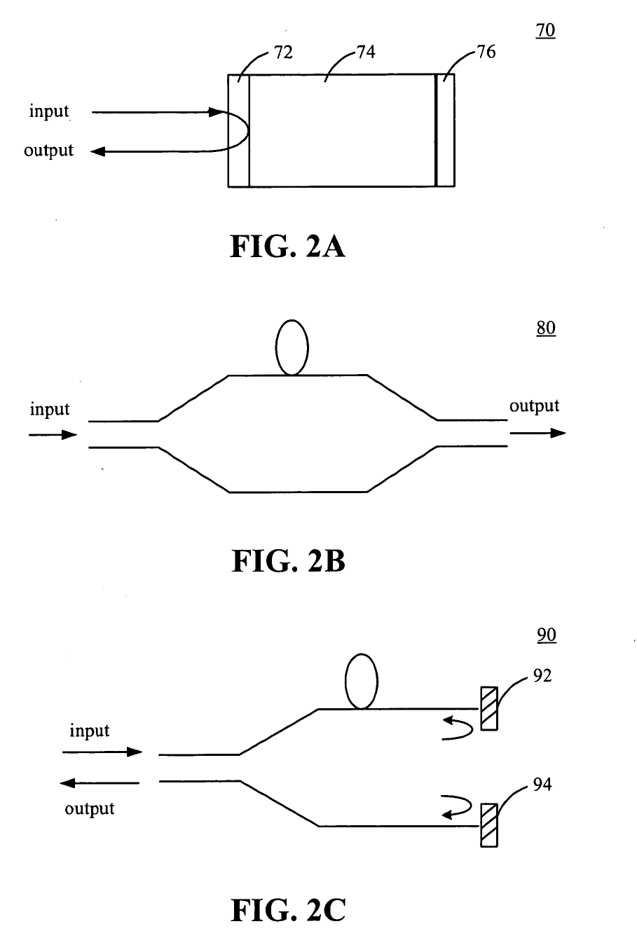

Please refer to FIG. 2A. FIG. 2A illustrates a diagram of Fabry-Perot etalon 70. After light enters Fabry-Perot etalon 70, two reflected light beams having different delay times are generated. One reflected light beam is reflected by a reflection coating 72, and the other reflected beam is reflected by a transmission medium 74 and a reflection coating 76. Due to the different delay times of the two reflected light beams, outputs of the two reflected light beams from Fabry-Perot etalon 70 have a time difference. The time difference is an optical path difference. Different modulated signals are generated by adjusting the optical path difference.

Please refer to FIG. 2B. FIG. 2B illustrates a diagram of Mach-Zehnder interferometer 80. After light enters Mach-Zehnder interferometer 80, the light passes two different paths. Due to the delay times of the two different paths are different, outputs of the two different paths from Mach-Zehnder interferometer 80 have a time difference. The time difference is an optical path difference. Different modulated signals are generated by adjusting the optical path difference.

Please refer to FIG. 2C. FIG. 2C illustrates a diagram of Michelson interferometer 90. After light enters Michelson interferometer 90, the light passes two different paths. Due to the delay times of the two different paths are different and the light of the two different paths are reflected by two reflected surfaces 92, 94, outputs of the two different paths from Michelson interferometer 90 have a time difference. The time difference is an optical path difference. Different modulated signals are generated by adjusting the optical path difference.

The wavelength variable light source 14 of the optical line terminal 10 in FIG. 1 can be a laser light source having an adjustable wavelength for generating the first optical signal whose frequency varies with time. For example, a signal source of the wavelength adjustable laser light source is one selected from a group consisting of triangular wave, sawtooth wave, and sine wave. Because the speed of light is a constant value and wavelength multiplied by frequency is the speed of light (c=λf, wherein c represents the speed of light, λ represents wavelength, and f represents frequency.), it is known that the frequency adjustment of the wavelength variable light source 14 serves the same function as the wavelength adjustment of the wavelength variable light source 14. Accordingly, the wavelength variable light source 14 serves the same function as a frequency variable light source.

The first optical signal is demultiplexed by the wavelength multiplexing/demultiplexing devices 54 and then transmitted to the beam splitter unit 50 which is 1×N via optical fiber 52. The beam splitter 50 is an optical device which splits the first optical signal in N, and the beam splitter 50 is denoted as 1×N therefore. The quantity 1 represents one first optical signal, and the quantity N depends on quantities of the optical network units. The beam splitter unit 50 transmits the first optical signal to the wavelength multiplexing/demultiplexing devices 56, 58, 60, and the wavelength multiplexing/demultiplexing devices 56, 58, 60 demultiplex the first optical signal to the optical network unit 20, 30, 40 respectively. Because the optical interference devices 24, 34, 44 have different optical path differences, i.e., different delay times, the optical interference devices 24, 34, 44 are passed by the first optical signal and reflect back the second optical signals with different frequencies. The second optical signals with different frequencies respectively are multiplexed by the wavelength multiplexing/demultiplexing devices 56, 58, 60 and transmitted to the wavelength multiplexing/demultiplexing devices 54 via the optical fiber 52. Then, the second optical signals are demultiplexed by the wavelength multiplexing/demultiplexing device 54 and transmitted to the optical line terminal 10. Each of the frequencies corresponding to each of the second optical signals is proportional to the delay time of the corresponding optical interference device. That is, when the delay time of each of the optical interference devices 24, 34, 44 is longer, the interference frequency of each of the second optical signals which are reflected by the optical interference devices 24, 34, 44 is higher. On the contrary, when the delay time of each of the optical interference devices 24, 34, 44 is reduced, the interference frequency of each of the second optical signals which are reflected by the optical interference devices 24, 34, 44 is decreased. Because the different delay time of each of the optical interference devices 24, 34, 44 means a different optical path difference, the frequency of each of the second optical signals is proportional to the optical path difference in different paths or multiple paths of each of the optical interference devices 24, 34, 44.

The optical circulator 18 ensures that the second optical signals are transmitted unidirectionally from the optical interference devices 24, 34, 44 to the optical/electrical converter unit 16 instead of the wavelength variable light source 14. The optical/electrical converter unit 16, such as an optical receiver, converts the second optical signals being transmitted from the optical interference devices 24, 34, 44 into electrical signals of different frequencies. A spectrum analyzing unit 62 is utilized for extracting a frequency component from each of the electrical signals. By analyzing the frequency component of each of the electrical signals, statuses of the optical fiber 52 from the optical line terminal 10 to the optical network units 20, 30, 40 can be detected. The spectrum analyzing unit 62, for example, is an electrical spectrum analyzer, an oscilloscope, or a signal processing circuit being capable of detecting frequency but not limited to the above examples.

In another embodiment, the wavelength variable light source 14 includes an amplified spontaneous emission (ASE) light source (not shown) and an adjustable optical filter (now shown). The adjustable optical filter is utilized for outputting an output wavelength which corresponds to a broad spectrum light and varies with time when the broad spectrum light passes the amplified spontaneous emission light source, and then the first optical signal having different wavelengths can be generated.

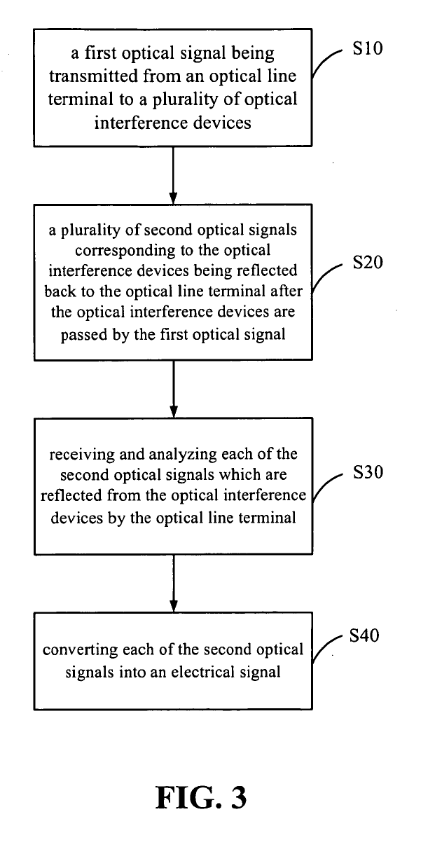

Please refer to FIG. 3. FIG. 3 illustrates a flow chart of an optical network monitoring method according to the present invention. In step S10, an optical line terminal transmits a first optical signal, and a beam splitter unit distributes and transmits the first optical signal to a plurality of optical network units. Each of the optical network units has an optical interference device. The first optical signal is generated by a wavelength variable light source, and a wavelength of the first optical signal varies with time. A signal source of the wavelength variable light source is one selected from a group consisting of triangular wave, sawtooth wave, and sine wave. In another embodiment, the wavelength variable light source includes an amplified spontaneous emission light source and an adjustable optical filter. The adjustable optical filter is utilized for outputting an output wavelength which corresponds to a broad spectrum light and varies with time when the broad spectrum light passes the amplified spontaneous emission light source, and then the first optical signal having different wavelengths can be generated.

In step S20, after the optical interference devices are passed by the first optical signal, the optical interference devices would reflect back a plurality of second optical signals corresponding to the optical interference devices. The second optical signals have different optical path differences (i.e. different delay times). Each of the optical interference devices would have a different free spectrum range, and is one selected from a group consisting of Fabry-Perot etalon, Mach-Zehnder interferometer, and Michelson interferometer. That is, each of the optical interference devices is one of the three interferometers or combinations of the three interferometers. Each of a plurality of frequencies corresponding to each of the second optical signals is proportional to the delay time of the optical interference device. That is, when the delay time of each of the optical interference devices is longer, the interference frequency of each of the second optical signals which are reflected by the optical interference devices is higher. On the contrary, when the delay time of each of the optical interference devices is reduced, the interference frequency of each of the second optical signals which are reflected by the optical interference devices is decreased. Because the different delay time of each of the optical interference devices would mean a different optical path difference, the frequencies corresponding to the second optical signals are proportional to the optical path difference in different paths or multiple paths corresponding to the optical interference devices.

In step S30, the optical line terminal receives and analyzes the second optical signals being reflected from the optical network units, and each of the frequencies corresponding to each of the second optical signals is differentiated.

In step S40, an optical/electrical converter unit converts each second optical signal into an electrical signal. A spectrum analyzing unit is utilized for analyze the electrical signal to extract a frequency component of the electrical signal. By analyzing the frequency component of each electrical signal, statues of the optical fiber from the optical line terminal to the optical network units can be known. A spectrum analyzing method, for example, is a use of an electrical spectrum analyzer, an oscilloscope, a signal processing circuit which is capable of detecting frequency, or a corresponding signal analyzing circuit but not limited to the above examples.

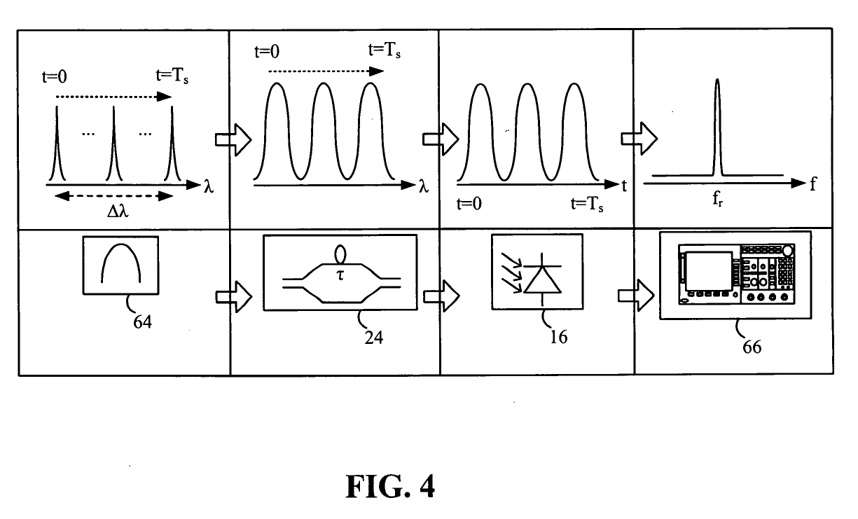

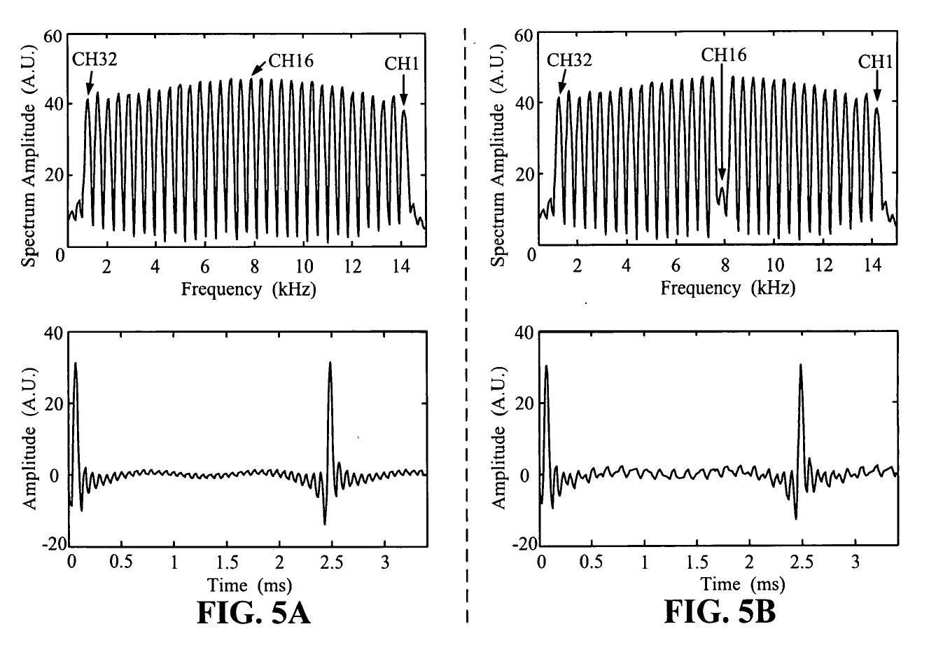

Please refer to FIG. 1 and FIG. 4. FIG. 4 illustrates waveform diagrams of various elements in a channel of the optical network monitoring system according to the present invention. The first waveform diagram is a first optical signal. The first optical signal is generated by an adjustable optical filter 64 when a broad spectrum light passed an amplified spontaneous emission light source. After the first optical signal is scanned and the optical interference device 24 is passed by the first optical signal, a second optical signal shown in the second waveform diagram is generated. The optical/electrical converter unit 16 such as an optical receiver converts the second optical signal into an electrical signal, and the electrical signal mapped in a time domain is shown in the third waveform diagram. After Fourier transform of the electrical signal, a spectrum observed by an oscilloscope 66 is shown in the fourth waveform diagram. By analyzing different frequencies of spectrums being reflected by optical interference devices, statuses of each channel in the optical network monitoring system can be known. Please refer to FIG. 5A and FIG. 5B. FIG. 5A illustrates stimulated waveform diagrams in a frequency domain and a time domain when the optical network monitoring system of the present invention is in a normal condition. FIG. 5B illustrates stimulated waveform diagrams in a frequency domain and in a time domain when the optical network monitoring system of the present invention includes a broken of a channel. Statuses of 32 channels can not be distinguished in the waveform diagram of the time domain in FIG. 5A, but statuses of the 32 channels can be distinguished in the waveform diagram of the frequency domain in FIG. 5A. The waveform diagram of the frequency domain in FIG. 5A shows that the 32 channels are all in normal statuses. In another aspect, the waveform diagram of the time domain in FIG. 5B is almost not different with the waveform diagram of the time domain in FIG. 5A. However, in comparison with the waveform diagram of the frequency domain in FIG. 5A, the channel 16 includes no frequency component in the waveform diagram of the frequency domain in FIG. 5B. The fact that the channel 16 includes no frequency component represents that the channel 16 is broken and can not reflect the second optical signal to the optical line terminal. Therefore, no any signal of the channel 16 can be observed in the optical line terminal.

Advantages of the present invention are described as follows. The first, the optical interference device of each optical network unit reflects back different frequency of the second optical signal, so a status of each optical network unit can be monitored by analyzing the frequency of each optical network unit with the spectrum analyzing unit. Therefore, when lengths of fiber branches are similar and at least one error occurs in the fiber branches at the same time, or errors occur in a dead zone of an optical time domain reflectometer, the present invention can still distinguish where the error or errors have occurred. The second, the optical interference devices utilized in the present invention are low cost, capable of being manufactured in large quantity, and capable of being integrated. For example, each optical interference device is one selected from a group consisting of Fabry-Perot etalon, Mach-Zehnder interferometer, and Michelson interferometer. After each optical interference device reflects back the second optical signal, the second optical signal is converted into the electrical signal by the optical/electrical converter unit. By the above-mentioned simple signal processing, the optical network monitoring system of the present invention can be built easily and applied to a passive optical network.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An optical network monitoring system, comprising:
an optical line terminal having a wavelength variable light source, for transmitting a first optical signal;
a plurality of optical interference devices, for being passed by the first optical signal and reflecting back a plurality of second optical signals corresponding to the optical interference devices respectively to the optical line terminal, wherein the second optical signals have different optical path differences;
a beam splitter unit connected to the optical line terminal and the optical interference devices via optical fiber respectively, for distributing and transmitting the first optical signal to the optical interference devices;
an optical/electrical converter unit, for converting each of the second optical signals into an electrical signal; and
a spectrum analyzing unit, for analyzing the electrical signal to extract a frequency component of the electrical signal.

2. The optical network monitoring system of claim 1, wherein the wavelength variable light source is a wavelength adjustable laser light source, and an output wavelength of the wavelength adjustable laser light source varies with time.

3. The optical network monitoring system of claim 1, wherein an output wavelength of the wavelength adjustable light source is modulated with time, and a signal source of the wavelength adjustable light source is one selected from a group consisting of triangular wave, sawtooth wave, and sine wave.

4. The optical network monitoring system of claim 1, wherein the wavelength variable light source further comprises:
an amplified spontaneous emission light source; and
an adjustable optical filter, for outputting an output wavelength which corresponds to a broad spectrum light and varies with time when the broad spectrum light passes the amplified spontaneous emission light source.

5. The optical network monitoring system of claim 1, wherein each of the optical interference devices is one selected from a group consisting of Fabry-Perot etalon, Mach-Zehnder interferometer, and Michelson interferometer.

6. The optical network monitoring system of claim 1, wherein each of the optical interference devices is disposed in an optical network unit.

7. The optical network monitoring system of claim 1, wherein the optical interference devices are disposed in a plurality of output ports of the beam splitter unit, respectively.

8. The optical network monitoring system of claim 1, wherein the spectrum analyzing unit is a signal processing circuit which is capable of detecting a signal frequency.

9. The optical network monitoring system of claim 1, wherein each of a plurality of frequencies corresponding to each of the electrical signals is differentiated, and the frequencies corresponding to the electrical signals are proportional to the optical path differences of the optical interference devices, respectively.

10. An optical network monitoring method, comprising steps of:
a first optical signal being transmitted from an optical line terminal to a plurality of optical interference devices;
a plurality of second optical signals corresponding to the optical interference devices being reflected back to the optical line terminal after the optical interference devices are passed by the first optical signal, wherein the second optical signals have different optical path differences; and
receiving and analyzing each of the second optical signals which are reflected from the optical interference devices by the optical line terminal.

11. The optical network monitoring method of claim 10, wherein the step of receiving and analyzing each of the second optical signals which are reflected from the optical interference devices by the optical line terminal further comprising a step of:
converting each of the second optical signals into an electrical signal.

12. The optical network monitoring method of claim 10, wherein a beam splitter distributes and transmits the first optical signal to the optical interference devices.

13. The optical network monitoring method of claim 10, wherein a wavelength adjustable light source generates the first optical signal, and an output wavelength of the wavelength adjustable light source varies with time.

14. The optical network monitoring method of claim 13, wherein a signal source of the wavelength adjustable light source is one selected from a group consisting of triangular wave, sawtooth, and sine wave.

15. The optical network monitoring method of claim 10, wherein an adjustable optical filter outputs the first optical signal when a broad spectrum light passes an amplified spontaneous emission light source.

16. The optical network monitoring method of claim 10, wherein each of the optical interference devices is one selected from a group consisting of Fabry-Perot etalon, Mach-Zehnder interferometer, and Michelson interferometer.

17. The optical network monitoring method of claim 10, wherein an optical/electrical convert unit converts each of the second optical signals into an electrical signal.

18. The optical network monitoring method of claim 17, wherein each of a plurality of frequencies corresponding to each of the electrical signals is differentiated, and the frequencies corresponding to the electrical signals are proportional to the optical path differences of the optical interference devices, respectively.

19. The optical network monitoring method of claim 12, wherein the optical interference devices are disposed in a plurality of output ports of the beam splitter unit, respectively.

20. The optical network monitoring method of claim 10, wherein each optical interference device is disposed in an optical network unit.
